(19) United States
(12) Patent Application Publication
(10) Pub. No.: US 2025/0256474 A1
(43) Pub. Date: Aug. 14, 2025

(54) CUTTING DEVICE AND METHOD FOR CUTTING A TIRE COMPONENT

(71) Applicant: VMI HOLLAND B.V., Epe (NL)

(72) Inventors: Jochem Johannes VAN STEENIS, Epe (NL); Mattheus Jacobus KAAGMAN, Epe (NL)

(21) Appl. No.: 18/865,094

(22) PCT Filed: Apr. 12, 2023
(86) PCT No.: PCT/NL2023/050188

§ 371 Date: Nov. 12, 2024

(30) Foreign Application Priority Data
May 18, 2022 (NL) 2031907

(51) Int. Cl. B29D 30/46; B26D 3/00; B26D 7/02

(52) U.S. Cl. CPC B29D 30/46; B26D 3/003; B26D 7/02; B29D 2030/463

(57) ABSTRACT

A cutting device and a method for cutting a tire component are provided. The cutting device comprises a conveyor that defines a conveyor plane. The cutting device comprises a lifting beam for lifting the tire component up from the conveyor plane in a lift direction. The cutting device is provided with a knife for cutting the tire component along a cutting line intersecting with the lifting beam at a cutting center at an oblique cutting angle. The cutting device is provided with a first hold-down unit for holding down the tire component towards the conveyor in a hold-down direction opposite to the lift direction. The first hold-down unit comprises a contact member for holding down the tire component in the hold-down direction towards the conveyor at a first hold-down position within a hold-down radius of less than one-hundred-and-fifty millimeters from the cutting center.

### BACKGROUND

The invention relates to a cutting device and a method for cutting a tire component, in particular a breaker ply, for manufacturing an unvulcanized or green tire.

WO 2008/105655 A2 discloses a cutting device for cutting a rubber component for a green belt. The cutting device comprises a roller conveyor for conveying the rubber component in a direction of conveyance. The roller conveyor comprises a number of conveyor rollers which are substantially parallel to and spaced apart from each other. The cutting device comprises a knife for cutting the rubber component at an oblique angle with the direction of conveyance, wherein the cutting device is provided with a lifting beam that extends transverse to the direction of conveyance between two conveyor rollers. The lifting beam is vertically movable for lifting the rubber component.

In order to be able to convey the rubber component correctly on the roller conveyor and to hold it in position, pressure rollers are arranged at a few millimetres above the roller conveyor in front of and at the other side behind the knife, considered in the direction of conveyance, to hold the rubber component down towards the roller conveyor at the location of said pressure rollers when the part of said rubber component between the pressure rollers is lifted by the lifting beam.

### SUMMARY OF THE INVENTION

The pressure rollers of the known cutting device as disclosed in WO 2008/105655 A2 can effectively hold down parts of the rubber component that would otherwise be lifted by the lifting beam by pressing said parts down on the roller conveyor on opposite sides of the cutting line, thereby creating slopes in the rubber component at said lifting beam into which the knife, travelling at an oblique angle to said lifting beam, can cut more accurately.

The pressure rollers work particularly well with a rubber component that is relatively wide. Because of the width of said wide rubber component, the lifting beam lifts up a relatively large area and the pressure rollers, positioned at a relatively large distance from the cutting line, can effectively press down sections of said wide rubber component that would otherwise be lifted together with the lifting beam.

However, when cutting a narrow tire component such as narrow breaker plies or chafers, e.g. less than one-hundred millimeters, the lifted area of the narrow tire component is much smaller and the pressure rollers, at the distance from the cutting line as disclosed in WO 2008/105655 A2, would not have an effect on the positioning of the narrow tire component. The known pressure rollers can not be moved closer to the cutting line because the pressure rollers or the support structure supporting said pressure rollers would collide with the knife or a knife holder holding said knife.

It is an object of the present invention to provide a cutting device and a method for cutting a tire component, wherein relatively narrow tire component can be cut.

According to a first aspect, the invention provides a cutting device for cutting a tire component, wherein the cutting device comprises a conveyor that defines a conveyor plane for conveying the tire component in a conveyance direction parallel to said conveyor plane, wherein the cutting device further comprises a lifting beam for lifting the tire component up from the conveyor plane in a lift direction, wherein the cutting device is provided with a knife for cutting the tire component along a cutting line intersecting with the lifting beam at a cutting center at an oblique cutting angle, wherein the cutting device is provided with a first hold-down unit for holding down the tire component towards the conveyor in a hold-down direction opposite to the lift direction, wherein the first hold-down unit comprises a contact member for holding down the tire component in the hold-down direction towards the conveyor at a first hold-down position adjacent to the lifting beam within a hold-down radius of less than one-hundred-and-fifty millimeters from the cutting center.

By providing the contact member of the first hold-down unit at the first hold-down position sufficiently close to the cutting center, a part of a relatively narrow tire component extending at said first hold-down position can be effectively held down towards the conveyor to facilitate the cutting process.

Preferably, the hold-down radius is less than eighty millimeters from the cutting center and preferably less than sixty millimeters from the cutting center. With these reduced ranges of the hold-down radius, an even narrower tire component can be held down effectively.

In one embodiment the first hold-down position is spaced apart from the cutting line in a direction perpendicular to said cutting line over a hold-down distance of less than eighty millimeters. Hence, the first hold-down position can be sufficiently close to the cutting line to effectively hold down a part of a relatively narrow tire component near said cutting line.

In a further embodiment, that may also be applied independently from the hold-down radius, the cutting device comprises a knife holder for moving the knife along the cutting line, wherein the contact member extends at least partially between the knife holder and conveyor for at least one value of the oblique cutting angle and in at least one position of the knife along the cutting line. In other words, the contact member can at least partially fit in the space between the knife holder and the conveyor. Hence, the contact member can be positioned even close to the cutting line without interfering or colliding with the knife holder.

In another embodiment, that may also be applied independently from the hold-down radius, the first hold-down unit comprises a base for holding the contact member in the first hold-down position and a support member for interconnecting the contact member with the base. By providing a support member between the contact member and the base, the contact member can be spaced apart from the base. In other words, the base can be spaced apart from the contact member. Hence, the dimensioning of the base does not negatively impact the ability of the contact member to be positioned close to the cutting line. In particular, the base can be relatively bulky without interfering or colliding with the knife and/or the knife holder.

Preferably, the support member spaces the contact member apart from the base over a spacing distance of at least fifty millimeters, preferably over at least one-hundred millimeters and most preferably at least one-hundred-and-fifty millimeters. Such a spacing distance may be sufficient for the base to remain clear off the knife and/or the knife holder when the knife is moved along the cutting line.

In another embodiment, that may also be applied independently from the hold-down radius, the contact member is rotatable about a first rolling axis. The rotation of the contact member can reduce friction between the contact member and the tire component when the contact member contacts said tire component. Hence, it can be prevented that the holding down of the tire component with the contact member adds tension in the tire component or deforms the tire component. In particular, the contact member may roll over the tire component rather than pull on the tire component when there is a relatively movement between the contact member and the tire component. Such a relative movement may occur when the contact member presses down on the tire component in the hold-down direction or when the tire component is so tacky that is does not immediately release from the contact member when the conveyor advances the tire component in the conveyance direction.

Preferably, the first rolling axis extends at an oblique rolling angle to the conveyor plane. More preferably, the oblique rolling angle is within a range of one to forty-five degrees. At said oblique rolling angle, the base may be positioned well above the conveyor plane while the contact member may be located closer to, near or at the conveyor plane. Consequently, the base can be relatively bulky without interfering with the tire component on the conveyor.

In a further embodiment the first hold-down unit comprises a rotational bearing coaxial to the first rolling axis. Hence, the contact member and the rotational bearing can be arranged in-line or coaxially, thereby greatly simplifying the mechanism for rotating said contact member compared to a non-coaxial arrangement.

In one embodiment the first hold-down unit comprises a base for holding the contact member in the first hold-down position and a support member for interconnecting the contact member with the base, wherein the rotational bearing is located between the base and the support member. By providing the rotational bearing at the base, the contact member can be more compact, thus allowing it to be moved closer to the cutting center without interfering or colliding with the knife and/or the knife holder. In particular, the dimensioning of said contact member is not in any way constricted by the minimal dimensions of the rotational bearing.

More preferably, the support member extends coaxially to the first rolling axis. Hence, the support member can be rotated together with the contact member about the first rolling axis while extending coaxially along said first rolling axis. The support member may be designed to have a minimal or uniform cross section about the first rolling axis. The support member may for example be shaped as a cylindrical rod extending concentrically to said first rolling axis.

In a further embodiment the support member is rotationally fixed with respect to the contact member. Thus, when the support member is made to be rotatable, this will also allow rotation of the contact member. Therefore, any means for facilitating said rotation, such as bearings, can be positioned along, at or in the support member, spaced apart from the contact member. The contact member itself can thus be designed to be more compact.

In a further embodiment the contact member and the support member are integrally formed. By manufacturing the contact member and the support member as a single piece, no connection needs to be made between the support member and the contact member, allowing for an even more compact design of the contact member. In particular, no fasteners are required and/or no material needs to be added to establish a connection.

Alternatively, the first hold-down unit comprises a base for holding the contact member in the first hold-down position and a support member for interconnecting the contact member with the base, wherein the rotational bearing is located between the support member and the contact member. Although in this situation the contact member may be less compact compared to the previous embodiments, the support member does not need to be designed for rotation and may therefore extend non-coaxially or non-linearly.

In another embodiment the contact member is at least partially spherical. In contrast to the cylindrical pressure rollers of the prior art, the least partially spherical contact member can contact the tire component in a uniform manner regardless of the orientation of the tire component relative to the spherical surface of the contact member. Moreover, in case the first rolling axis is arranged at an oblique rolling angle in accordance with one of the aforementioned embodiments, the spherical surface of the contact member may still uniformly contact and/or roll over a part of tire component extending in a different orientation to said first rolling axis.

Alternatively, the contact member comprises a beveled, chamfered or rounded edge. It will be understood by one skilled in the art that the contact member does not need to be fully spherical. Instead, the contact member may be provided with a strategically positioned edge that is beveled, chamfered or rounded to compensate for the oblique rolling angle and/or an offset between the orientation of the contact member and the part of the tire component that is being held down by said contact member.

In another embodiment the contact member has an outer dimension in the hold-down direction of less than thirty millimeters, preferably less than twenty-five millimeters and most preferably less than twenty millimeters. By limiting the outer dimension to one of the ranges specified above, the contact member can approach the cutting line very closely, or even extend between the knife holder and the conveyor in the holding direction. In particular, when the contact member is spherical or at least partially spherical, the spherical section can be provided with an outer diameter corresponding to the outer dimension as specified above.

In another embodiment the first hold-down unit is arranged for holding down the tire component towards the conveyor at a first side of the cutting line. In other words, the contact member does not extend beyond the first cutting line.

Preferably, the contact member of the first hold-down unit is fully located in a first hold-down area included in an obtuse angle between the cutting line and the lifting beam at the first side of said cutting line. In other words, the contact member does not extend beyond said first hold-down area. Hence, the part of the tire component extending in said first hold-down area can be actively held down, whereas the other part of the tire component is not actively held down and can be picked up by the knife as the knife cuts through the tire component along the cutting line.

In another embodiment the cutting device comprises a second hold-down unit with a contact member for holding down the tire component in the hold-down direction towards the conveyor at a second hold-down position adjacent to the lifting beam at a second side of the cutting line opposite to the first side. Hence, the tire component can be held down towards the conveyor on opposite sides of the cutting line. In particular, one of the first hold-down position and the second hold-down position is located upstream of the lifting beam in the conveyance direction and the other of the first hold-down position and the second hold-down position is located downstream of the lifting beam.

Preferably, the contact member of the second hold-down unit is fully located in a second hold-down area included in an obtuse angle between the cutting line and the lifting beam at the second side of said cutting line. Hence, the part of the tire component extending in said second hold-down area can be actively held down, whereas the other part of the tire component is not actively held down and can be picked up by the knife as the knife cuts through the tire component along the cutting line.

In a further embodiment the second hold-down position is within the hold-down radius from the cutting center. This has the same technical advantages as described earlier in relation to the first hold-down position being within the hold-down radius.

In another embodiment the cutting device is provided with a first clamp unit for clamping the tire component on the lifting beam at a first side of the cutting line. The clamping can prevent shifting of the tire component at the cutting line, thereby improving the accuracy of the cutting.

Preferably, the first clamp unit is arranged to move together with the first hold-down unit. The first clamp unit and the first hold-down unit may for example be moved together in the hold-down direction or the lift direction. When lifting both the first hold-down unit and the first clamp unit in the lift direction, they can be moved clear from the conveyor, allowing for sufficient space to advance the tire component in the conveyance direction without the first hold-down unit and the first clamp unit interfering with said conveyance.

In particular, the cutting device is provided with a first holder for simultaneously supporting the first hold-down unit and the first clamp unit. Hence, the first hold-down unit and the first clamp unit can both be moved by moving a common first holder, thus requiring only a single drive, instead of two individual drives.

In another embodiment the first clamp unit comprises a finger. Preferably, the finger is resilient. The finger can press the tire component onto the lifting beam with a clamping force to ensure proper fixation of the tire component on the lifting beam during the cutting process.

In another embodiment the cutting device is provided with a second clamp unit for clamping the tire component on the lifting beam at a second side of the cutting line, opposite to the first side. The second clamp unit can further improve the cutting accuracy by also clamping the tire component on the lifting beam at the second side of the cutting line.

Preferably, the cutting device comprises a second hold-down unit for holding down the tire component in the hold-down direction towards the conveyor at the second side of the cutting line, wherein the second clamp unit is arranged to move together with the second hold-down unit. When lifting both the second hold-down unit and the second clamp unit in the lift direction, they can be moved clear from the conveyor, allowing for sufficient space to advance the tire component in the conveyance direction without the second hold-down unit and the second clamp unit interfering with said conveyance. In particular, when all of the hold-down units and the clamp units are lifted in the lift direction, they can all be kept clear from and at sufficient distance from the conveyor to allow for advancing of the tire component underneath.

According to a second aspect, the invention provides a method for cutting a tire component, wherein the method comprises the steps of:
providing a conveyor that defines a conveyor plane;
providing the tire component on the conveyor in said conveyor plane;
lifting the tire component up from the conveyor plane in a lift direction using a lifting beam;
cutting the tire component along a cutting line intersecting with the lifting beam at a cutting center at an oblique cutting angle; and
holding down the tire component towards the conveyor at a first hold-down position adjacent to the lifting beam within a hold-down radius of less than one-hundred-and-fifty millimeters from the cutting center.

By providing holding down the tire component at the first hold-down position sufficiently close to the cutting center, a part of a relatively narrow tire component extending at said first hold-down position can be effectively held down towards the conveyor to facilitate the cutting process.

Preferably, the tire component has a component width in a lateral direction perpendicular to the conveyance direction of less than one-hundred millimeters, preferably less than eighty millimeters and most preferably less than seventy millimeters. As mentioned above, the close positioning of the first hold-down position to the cutting center allows for cutting narrow tire components, in particular tire components as narrow as specified above. Examples of such narrow tire components are narrow breaker plies (normally wider than one-hundred millimeters) or chafers.

In a further embodiment the cutting angle is adjustable within a range of fifteen to seventy degrees. The first hold-down unit can thus be designed to position the contact member at the first hold-down position while the first hold-down unit should not collide with the knife and/or the knife holder at any cutting angle within the specified range.

According to an unclaimed third aspect, the invention provides a cutting device for cutting a tire component, wherein the cutting device comprises a conveyor that defines a conveyor plane for conveying the tire component in a conveyance direction parallel to said conveyor plane, wherein the cutting device further comprises a lifting beam for lifting the tire component up from the conveyor plane in a lift direction, wherein the cutting device further comprises a cutting member for cutting the tire component along a cutting line extending obliquely across the lifting beam in a cutting direction parallel to the conveyor plane, wherein the cutting device is provided with a first hold-down unit for holding down the tire component towards the conveyor adjacent to the lifting beam at a first side of the cutting line and a second hold-down unit for holding down the tire component towards the conveyor adjacent to the lifting beam at a second side of the cutting line opposite to the first side, wherein the cutting device is further provided with a first clamp unit and a second clamp unit for clamping the tire component on the lifting beam at the first side and the second side of the cutting line, respectively, wherein the cutting device comprises one or more drives for moving the first hold-down unit, the second hold-down unit, the first clamp unit and the second clamp unit in a hold-down direction transverse to the conveyor plane.

After cutting, the lifting beam is lowered to a position below the conveyor rollers and a new length of the tire component is advanced in the conveyance direction across the lifting beam. Although the hold-down units and the clamp units are only intended for contacting and holding down the tire component during cutting, they may occasionally contact the tire component as it is being advanced, for example when the tire component has not yet been fully lowered back onto the conveyor, when the tire component has irregularities, such as an imperfect splice or creases, or when the tire component is behaving unpredictably because it is being conveyed at a high speed. The tire component may for example jolt, come loose or jump up from the conveyor plane. Contact with the hold-down units and/or the clamp units may deform and/or damage the tire component, which can potentially have a negative impact on the cutting quality during the subsequent cutting process. When lifting up all of the hold-down units and all of the clamp units, it can be prevented that they contact or collide with the tire component being advanced or conveyed underneath.

In another embodiment the first hold-down unit and the second hold-down unit are movable in the hold-down direction between an inactive position at a first distance from the conveyance plane and an active position at a second distance from the conveyance plane, smaller than the first distance. In the active position, the hold-down units may actively hold down the tire component on or towards the conveyor. In the inactive position, the hold-down units can be spaced apart from the conveyor so as not to contact the tire component.

Preferably, the second distance is less than five millimeters, and preferably less than three millimeters. At said second distance, the tire component can be effectively held down towards or on the conveyor. The tire component may be even thinner, so the hold-down units do not necessarily contact the tire component all the time. They can merely prevent that the tire component moves up from the conveyor beyond the second distance.

In another embodiment the first distance is at least ten millimeters, preferably at least twenty millimeters and most preferably at least thirty millimeters. The first distance as specified should be sufficient to prevent unintentional contact between the tire component and the hold-down units in the inactive position. The larger the first distance, the lesser the risk of contact.

In another embodiment the first clamp unit is arranged to move together with the first hold-down unit in the hold-down direction. The first clamp unit and the first hold down unit are on the same first side of the cutting line. By moving the first clamp unit and the first hold down unit together, the tire component at said first side of the cutting line can be released.

Preferably, the cutting device is provided with a first holder for simultaneously supporting the first hold-down unit and the first clamp unit. Hence, the first hold-down unit and the first clamp unit can both be moved by moving the common first holder.

More preferably, the one or more drives comprises a first drive for moving the first holder in the hold-down direction. The first drive can be common drive for moving the first hold-down unit and the first clamp unit simultaneously.

In another embodiment the second clamp unit is arranged to move together with the second hold-down unit in the hold-down direction. By moving the second clamp unit and the second hold down unit together, the tire component at said second side of the cutting line can be released. The second clamp unit and the second hold-down unit may be moved together at a different moment in time to the first clamp unit and the first hold-down unit, for example for release one part of the tire component extending at the second side of the cutting line earlier than the other part of the tire component extending at the first side of the cutting line. In particular, when the second side of the cutting line is downstream of the cutting line, the part of the tire component that has been cut-off at said downstream side can be released earlier than the part of the tire component at the first side of the cutting line, to allow for advancing said cut-off part prior to feeding in a new length of the tire component across the cutting line.

Preferably, the cutting device is provided with a second holder for simultaneously supporting the second hold-down unit and the second clamp unit. Hence, the second hold-down unit and the second clamp unit can both be moved by moving the common second holder.

More preferably, the one or more drives comprises a second drive for moving the second holder in the hold-down direction. The second drive can be common drive for moving the second hold-down unit and the second clamp unit simultaneously.

Alternatively, the one or more drives comprises a plurality of drives for individually moving each one of the first hold-down unit, the second hold-down unit, the first clamp unit and the second clamp unit. Hence, each hold-down unit and each clamp unit can be controlled to move individually.

In another embodiment the first hold-down unit and the second hold-down unit each comprise a rotatable contact member. The rotation of the contact member can reduce friction between the contact member and the tire component when the contact member contacts said tire component. Hence, it can be prevented that the holding down of the tire component with the contact member adds tension in the tire component or deforms the tire component. In particular, the contact member may roll over the tire component rather than pull on the tire component when there is a relatively movement between the contact member and the tire component. Such a relative movement may occur when the contact member presses down on the tire component in the hold-down direction or when the tire component is so tacky that is does not immediately release from the contact member when the conveyor advances the tire component in the conveyance direction.

In another embodiment the first clamp unit and the second clamp unit each comprise a resilient finger. The finger can press the tire component onto the lifting beam with a clamping force to ensure proper fixation of the tire component on the lifting beam during the cutting process.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a top view of a cutting device according to a first exemplary embodiment of the invention;

FIG. 2 shows a side view of the cutting device according to FIG. 1 during a cutting step of a method for cutting a tire component;

FIG. 3 shows a side view of the cutting device according to FIG. 1 prior to or after the cutting step;

FIGS. 4, 5 and 6 show rear views of the cutting device according to FIGS. 1, 2 and 3, respectively;

FIG. 7 shows a cross section of the cutting device according to the line VII-VII in FIG. 1;

FIG. 8 shows a cross section of a first hold-down unit of the cutting device according to FIG. 1;

FIGS. 9, 10 and 11 show cross sections of alternative hold-down units according to second, third and fourth exemplary embodiments of the invention, respectively;

FIG. 12 shows a top view of an alternative cutting device according a fifth exemplary embodiment of the invention; and

FIG. 13 shows a top view of a further alternative cutting device according a sixth exemplary embodiment of the invention.

### DETAILED DESCRIPTION OF THE INVENTION

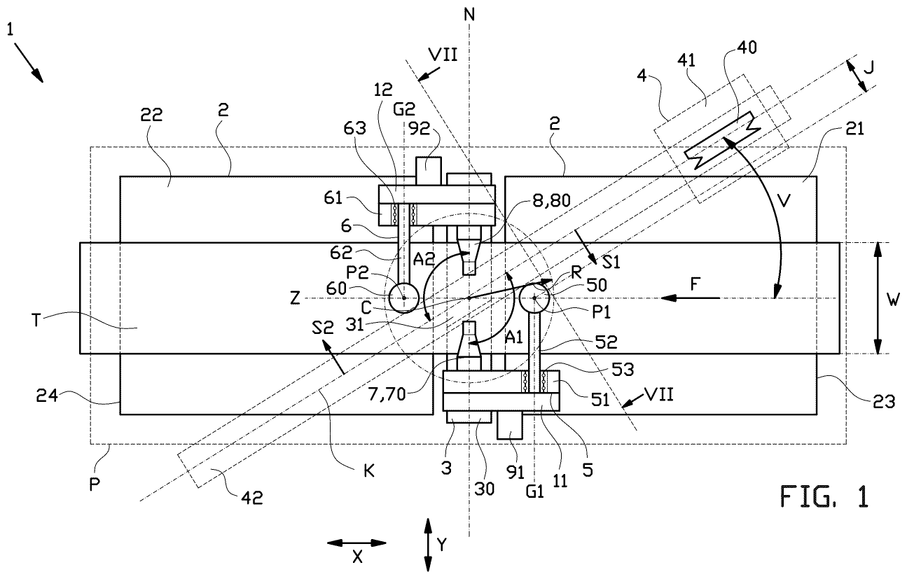

FIGS. 1-8 show a cutting device 1 according to a first exemplary embodiment for cutting a tire component T, in particular a breaker ply or a chafer.

The tire component T has a width W that is relatively narrow, for example less than one-hundred millimeters or less. In this example, the width W of the tire component T is approximately sixty millimeters. The tire component T typically comprises an elastomeric or rubber body and may be provided with reinforcement cords. The reinforcements cords extend at an oblique angle to the longitudinal direction of the tire component T. The tire component T has a thickness of only a few millimeters, for example less than three millimeters. In this example, the thickness of the tire component T is approximately one millimeter.

The tire component T is fed as a continuous length or strip towards the cutting device 1. The cutting device 1 is configured for cutting off a predetermined length of the tire component T to be used in a tire manufacturing process downstream of said cutting device 1.

As shown in FIG. 1, the cutting device 1 comprises a conveyor 2 for conveying the tire component T. The conveyor 2 defines a conveyor plane P in which the tire component T is conveyed. The conveyor 2 is configured for conveying the tire component T in a feeding direction or a conveyance direction F parallel to said conveyor plane P. The tire component T is fed onto the conveyor 2 with the longitudinal direction of the tire component T parallel to the conveyance direction F. FIG. 1 shows a longitudinal direction X that is therefore representative of both the longitudinal direction X of the conveyor 2 as well as the longitudinal direction X of the tire component T. FIG. 1 further shows a lateral direction Y extending transverse or perpendicular to the longitudinal direction Y and parallel to the conveyor plane P.

In this example, the conveyor 2 is a belt conveyor that has two conveyor sections 21, 22 arranged in line in the conveyance direction F. In particular, each conveyor section 21, 22 comprises a conveyor belt 23, 24 arranged in an endless loop around a number of pulleys. The upper run of each conveyor belt 23, 24 defines the conveyor plane P. Alternatively, the conveyor 2 may be a roller conveyor (not shown) similar to the roller conveyor in WO 2008/105655 A2. Such a roller conveyor comprises a plurality of rollers divided into two groups corresponding to the aforementioned conveyor sections 21, 22.

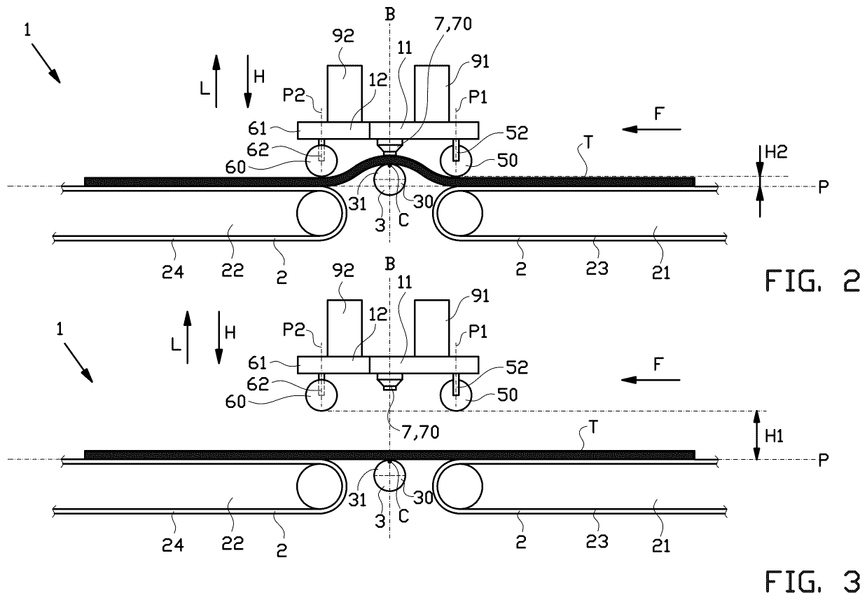

As best seen in FIGS. 2 and 3, the cutting device I further comprises a lifting member or lifting beam 3 for lifting the tire component T up from the conveyor plane P in a lift direction L. In this example, the lift direction L is perpendicular to the conveyor plane P. The lifting beam 3 comprises a beam body 30 extending between the conveyor sections 21, 22 in a direction transverse or perpendicular to the conveyance direction F. In particular, the lifting beam 3 has a centerline N extending in said direction transverse or perpendicular to the conveyance direction F. In other words, the beam body 30 extends parallel to the lateral direction Y. The lifting beam 3 is provided with a cutting gap or a cutting recess 31 in the beam body 3.

As shown in FIG. 1, the cutting device 1 is further provided with a cutter 4 for cutting the tire component T. The cutter 4 comprises a cutting member or a knife 40 and a knife holder 41 for holding said knife 40. In this example, the knife 40 is provided with a collar, similar to the one disclosed in WO 2008/105655 A2, for carrying the tire component T once the knife 40 has cut into and/or pierced the tire component T. The cutter 4 further comprises a cutting beam 42. The cutting beam 42 extends parallel or substantially parallel to the conveyor plane P. The knife holder 41 is movable along the cutting beam 42 to move the knife 40 along a cutting line K parallel to said cutting beam 42. The cutting line K is arranged at an oblique cutting angle V to the conveyance direction F. The oblique cutting angle V is measured in or parallel to the conveyor plane P. In particular the cutting line K intersects with the lifting beam 3 at a cutting center C. The cutting recess 31 in the lifting beam 3 is dimensioned and/or shaped to allow passage of the knife 40 through the beam body 30 at the cutting center C at said oblique cutting angle V.

In this example, the cutting beam 42 is rotatable about a cutting axis B, shown in FIGS. 2 and 3, extending perpendicular to the conveyor plane P through the cutting center C. By rotating the cutting beam 42, the oblique cutting angle V can be adjusted. In particular, the oblique cutting angle V is chosen to be parallel or substantially parallel to any reinforcement cords embedded at an oblique cord angle in the tire component T, such that the knife 40 may cut between the reinforcement cords without jumping over them. Preferably, the oblique cutting angle V is adjustable within a range of fifteen to seventy degrees.

As shown in FIG. 2, the cutting device 1 is provided with a first hold-down unit 5 and a second hold-down unit 6 for pressing down or holding down the tire component T towards or on the conveyor 2 in a pressing direction or a hold-down direction H opposite to the lift direction L. As shown by comparing FIGS. 2 and 3, the first hold-down unit 5 and the second hold-down unit 6 are movable in the hold-down direction H and the lift direction L towards and away from the conveyor 2 and/or the conveyor plane P. In particular, the first hold-down unit 5 and the second hold-down unit 6 can be moved from an inactive position, as shown in FIG. 3, at a first distance Hl from the conveyor plane P, up to an active position, as shown in FIG. 2, at a second distance H2 from the conveyor plane P, smaller than the first distance H1. The first distance H1 should be sufficient to prevent unintentional contact between the tire component T, as it being advanced or conveyed by the conveyor 2, and the hold-down units 5, 6 in the inactive position. The larger the first distance, the lesser the risk of contact. The first distance HI is at least ten millimeters. In this example, the first distance Hl is approximately fifty millimeters. The second distance H2 is less than five millimeters. In this example, the second distance H2 is approximately two millimeters. At said second distance H2, the tire component T can be effectively held down towards or on the conveyor 2.

As best seen in FIG. 1, the first hold-down unit 5 is configured for holding down the tire component T at a first pressing position or hold-down position P1 adjacent to the lifting beam 3 at a first side S1 of the cutting line K and the second hold-down unit 6 is configured for holding down the tire component T at a second pressing position or hold-down position P2 adjacent to the lifting beam 3 at a second side S2 of the cutting line K, opposite to the first side S1. In this example, the first hold-down position P1 and the second hold-down position P2 are within a hold-down radius R of less than one-hundred-and-fifty millimeters from the cutting center C. In this example, the hold-down radius R is less than one-hundred millimeters, and preferably approximately sixty millimeters.

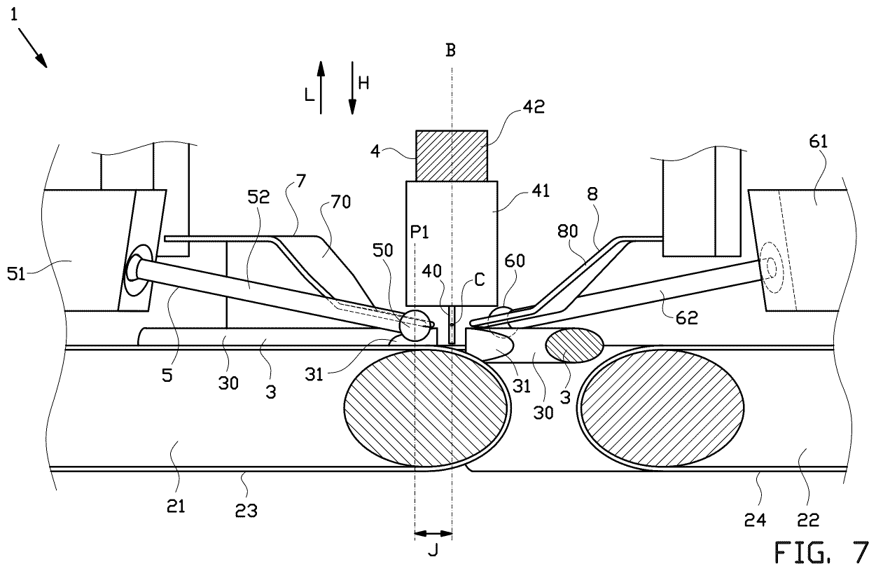

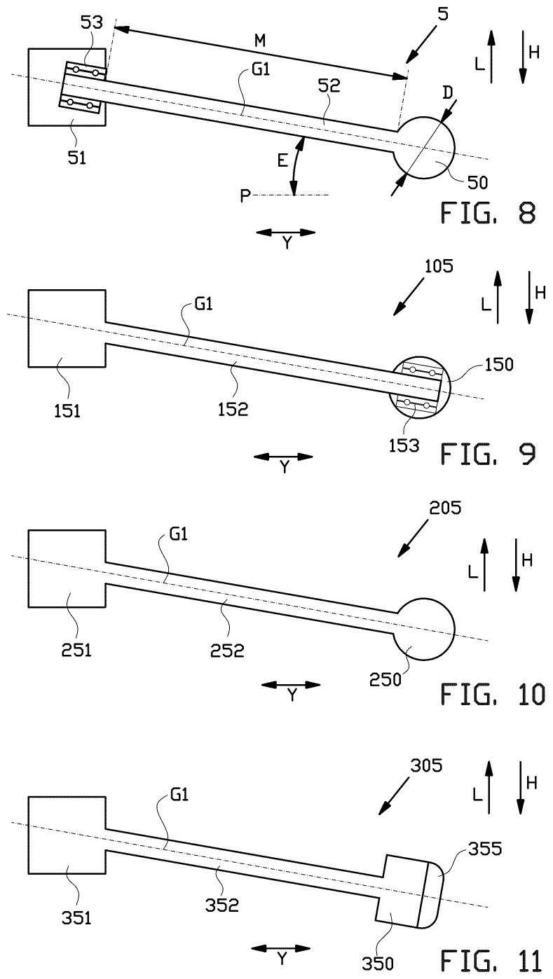

As best seen in FIG. 8, the first hold-down unit 5 comprises a contact member 50 for pressing down or holding down the tire component T in the hold-down direction H towards or on the conveyor 2 at the first hold-down position P1. In this example, the contact member 50 is spherical or has a spherical surface. In this example, considered in the hold-down direction H, the contact member 50 has an outer dimension or outer diameter D of less than thirty millimeters. In this example, the outer diameter D is approximately eighteen millimeters. As shown in FIG. 7, because of the relatively small outer dimension D, the contact member 50 may extend or be inserted at least partially between the knife holder 41 and conveyor 2.

As shown in FIG. 8, the contact member 50 is rotatable about a first rolling axis G1. In this example, the first rolling axis G1 extends at an oblique rolling angle E to the conveyor plane P. Said rolling angle E is within a range of one to forty-five degrees. In this example, the rolling angle E is approximately ten degrees.

The first hold-down unit 5 further comprises a base 51 for holding the contact member 50 in the first hold-down position P1 and a support member 52 for interconnecting the contact member 50 with the base 51. The support member 52 spaces the contact member 50 apart from the base 51 over a spacing distance M of at least fifty millimeters. In this example, the spacing distance M is approximately one-hundred-and-sixty millimeters. As shown in FIG. 7, the spacing is sufficient to keep the base 51 away from the knife 40 and/or the knife holder 41, even at an extreme oblique cutting angle V.

As further shown in FIG. 8, the support member 52 extends coaxially about the first rolling axis G1. Preferably, the support member 52 is narrower than the contact member 50. In particular, the support member 52 may be shaped as a thin or narrow rod that coincides with the first rolling axis G1. Preferably, the support member 52 is cylindrical. In that case, the support member 52 has an diameter equal to or smaller than the outer diameter D of the contact member 50. In other words, if the contact member 50 is termed the ‘head’ of the first hold-down unit 5, then the support member 52 would be considered the ‘neck’ portion connecting the ‘head’ to the base 51.

In the example as shown in FIG. 8, the first hold-down unit 5 comprises a rotational bearing 53 arranged coaxially to or in-line with the first rolling axis G1. The rotational bearing 53 is located between the base 51 and the support member 52. The support member 52 can thus be rotated about the first rolling axis G1 relative to the base 51. In particular, the support member 52 is rotationally fixed with respect to the contact member 50 such that both can rotate together or in unison about the first rolling axis G1. In this particular example, the contact member 50 and the support member 52 are integrally formed.

As best seen in FIG. 1, the second hold-down unit 6 comprises a contact member 60, a base 61, a support member 62 and a rotational bearing 63 having the same features, functionality and/or interactions as previously described in relation to the first hold-down unit 5. In fact, the first hold-down unit 5 and the second hold-down unit 6 may be identical and/or exchangeable. The second hold-down unit 6 will therefore not be described in further detail.

As shown in FIG. 1, the first hold-down position P1 is located in a first half of width of the conveyor 2 in the lateral direction Y whereas the second hold-down position is located in a second half of the width of the conveyor 2 in said lateral direction Y, opposite to the first half. In particular, the first hold-down unit 5 and the second hold-down unit 6 do not extend beyond the half width distance across the conveyor 2. Alternatively formulated, the contact member 50 of the first hold-down unit 5 is fully located in a first hold-down area A1 included in an obtuse angle between the cutting line K and the lifting beam 3 at the first side S1 of said cutting line K. In contrast, the contact member 60 of the second hold-down unit 6 is fully located in a second hold-down area A2 included in an obtuse angle between the cutting line K and the lifting beam 3 at the second side S2 of said cutting line K. The first hold-down unit 5 and the second hold-down unit 6 may be arranged point-symmetrically about the cutting center C at opposite sides S1, S2 of said cutting line K.

In this example, the contact member 60 is located at or near a longitudinal axis or center axis Z of the tire component T.

As further shown in FIG. 1, the cutting device 1 is provided with a first clamp unit 7 and a second clamp unit 8 for clamping the tire component T on the lifting beam 3 at the first side S1 and the second side S2, respectively, of the cutting line K. In particular, the first clamp unit 7 and the second clamp unit 8 are designed to clamp the tire component T on the beam body 30 of the lifting beam 3 as close as possible to the cutting recess 31 in said lifting beam 3. In this example, as shown in FIGS. 4 and 5, each clamp unit 7, 8 comprises a finger 70, 80, in particular a resilient or resiliently flexible finger 70, 80.

As shown in FIG. 2, the first hold-down unit 5 and the first clamp unit 7 are mounted on or supported by a first holder 11 for moving together or in unison in the hold-down direction H and the lift direction L. In particular, the cutting device 1 is provided with a first drive 91 common to the first hold-down unit 5 and the first clamp unit 7 for moving the first hold-down unit 5 and the first clamp unit 7 together or in unison.

Similarly, as best seen in FIG. 1, the second hold-down unit 6 and the second clamp unit 8 are mounted on or supported by a second holder 12 for moving together in the hold-down direction H and the lift direction L. The cutting device 1 is provided with a second drive 92 common to the second hold-down unit 6 and the second clamp unit 8.

The first drive 91 and the second drive 92 may be controlled such that all of the hold-down units 5, 6 and all of the clamp units 7, 8 are in the inactive position at the same time, as shown in FIG. 3. The drives 91, 92 may be controlled to move their respective hold-down units 5, 6 and clamp units 7, 8 simultaneously, or to move one set after the other, for example to release a cut-off length of the tire component T downstream of the cutting line L first. With all of the hold-down units 5, 6 and the clamp units 7, 8 in the inactive position, any interference of the hold-down units 5, 6 and the clamp units 7, 8 with the conveyance of the tire component T underneath can be effectively prevented.

FIG. 9 shows an alternative hold-down unit 105 according to a second exemplary embodiment of the invention, that differs from the hold-down unit 5 of FIG. 8 in that the rotational bearing 153 is located between the support member 152 and the contact member 150. Hence, the support member 152 may be rotationally fixed with respect to and/or integrally formed with the base 151. The contact member 150 is rotatable relative to said support member 152.

FIG. 10 shows a further alternative hold-down unit 205 according to a third exemplary embodiment of the invention, that differs from the hold-down unit 5 of FIG. 8 in that the contact member 250 is not rotatable about the first rolling axis G1. Instead, the contact member 250 may be rotationally fixed with respect to and/or integrally formed with the support member 252 and/or the base 251. Preferably, the contact member 250 is provided with a low-friction coating to reduce friction between the tire component T and the contact member 250.

FIG. 11 shows a further alternative hold-down unit 305 according to a fourth exemplary embodiment of the invention, that differs from the hold-down unit 5 of FIG. 8 in that the contact member 350 is provided with a beveled, chamfered or rounded edge 355. In particular, the edge 355 extends circumferentially about the first rolling axis G1. Although the contact member 350 is shown as if it where integrally formed with the support member 352 and/or the base 351, it will be appreciated that a rotational bearing may be provided in any of the positions as shown in FIG. 8 or 9 to enable rotation of said contact member 350 about the first rolling axis G1.

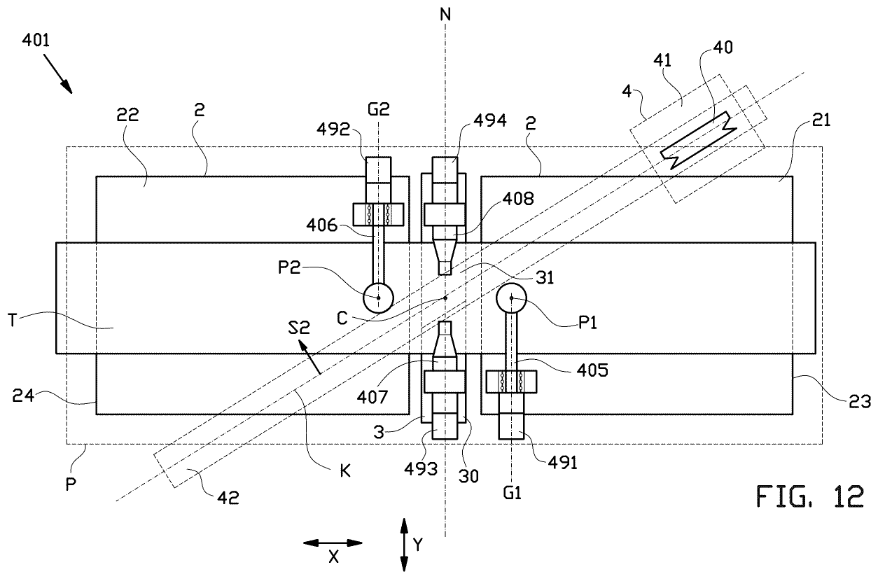

FIG. 12 shows an alternative cutting device 401 according to a fifth exemplary embodiment of the invention that differs from the cutting device 1 as shown in FIG. 1 in that the first hold-down unit 405, the second hold-down unit 406, the first clamp unit 407 and the second clamp unit 408 are all provided with their own dedicated or individual drive 491-494 to individually and/or independently control the movements thereof in the hold-down direction H and/or the lift direction L.

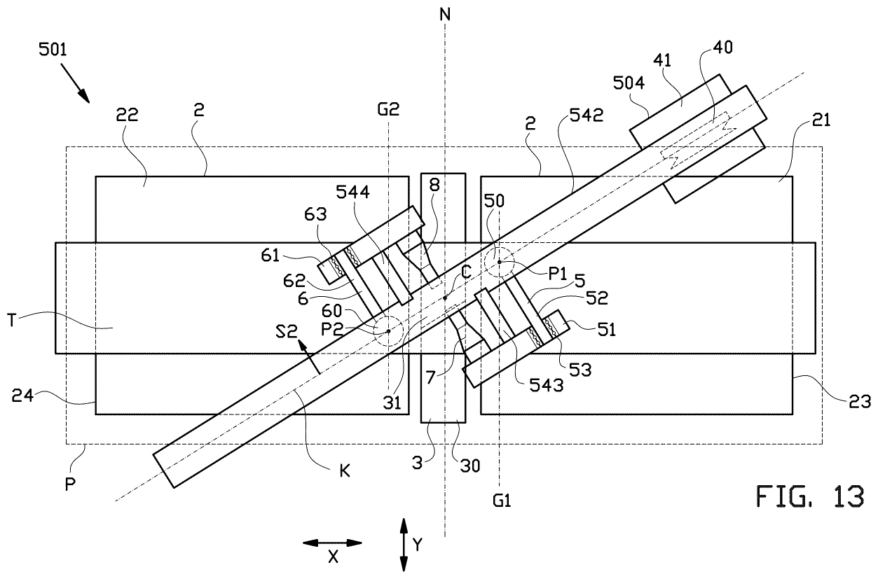

FIG. 13 shows a further alternative cutting device 501 according to a sixth exemplary embodiment of the invention that differs from the cutting device 1 as shown in FIG. 1 in that the cutter 504 is configured for holding, supporting or carrying at least one of the first hold-down unit 5, the second hold-down unit 6, the first clamp unit 7 and the second clamp unit 8. In particular, said at least one of the hold-down units 5, 6 or the clamp units 7, 8 is supported on or carried by the cutting beam 542. In this example, the first hold-down unit 5 and the first clamp unit 7 are connected directly to the cutting beam 542 via a first holder 543 and the second hold-down unit 6 and the first clamp unit 8 are connected directly to the cutting beam 542 via a first holder 544. Hence, the hold-down units 5, 6 and the clamp units 7, 8 can be adjusted in position together with the cutting beam 542 about the cutting center C.

A method for cutting a tire component T will now be briefly elucidated with reference to FIGS. 1-7.

FIG. 1 shows the situation in which the tire component T is provided on the conveyor 2 in the conveyor plane P. As shown in FIG. 4 the first hold-down unit 5 and the second hold-down unit 6 may be moved down into the active position at the second distance H2 from the conveyor plane P while the lifting beam 3 is still down or retracted, i.e. below or flush with the conveyor plane P. The clamp units 7, 8 have been moved together with said hold-down units 5, 6 and they may already loosely clamp the tire component T at the location of the lifting beam 3, or they may be floating just above the tire component T, waiting for the lifting beam 3 to be lifted.

Alternatively, the lifting beam 3 may be already be in the raised or lifted position, as shown in FIGS. 2 and 5, prior to the hold-down units 5, 6 and/or the clamp units 7, 8 moving down.

FIGS. 2 and 5 show the situation in which the lifting beam 3 has been raised or lifted to a level above the conveyor plane P. The hold-down units 5, 6 and the clamp units 7, 8 have been moved down to hold-down the tire component T towards or on the conveyor 2 and to clamp the tire component T on the lifting beam 3, respectively. The fingers 70, 80 may be at least partially flexed upwards when contacting the tire component T on the lifting beam 3.

As shown schematically in FIG. 5, the contact member 50 of the first hold-down unit 5 deflects only a part of the tire component T towards the conveyor 2 predominantly in the first hold-down position P1 with the rest of the tire component T still being raised by the lifting beam 3. Similarly, the contact member 60 of the second hold-down unit 6 deflects another part of the tire component T towards the conveyor 2 predominantly in the second hold-down position P2 with the rest of the tire component T still being raised by the lifting beam 3.

In this manner, the lifted part of the tire component T can be held in a diamond-like three dimensional shape having a crest at the cutting center C into which the initial cut can be made. Once the knife 40 has pierced the tire component T at said cutting center C the knife 40 is moved to one of the longitudinal sides of the tire component T and is subsequently moved in the opposite direction along the cutting line K to complete the cut towards the other longitudinal side of the tire component T. The knife 40 may be provided with the aforementioned collar to carry the tire component T during the cutting process.

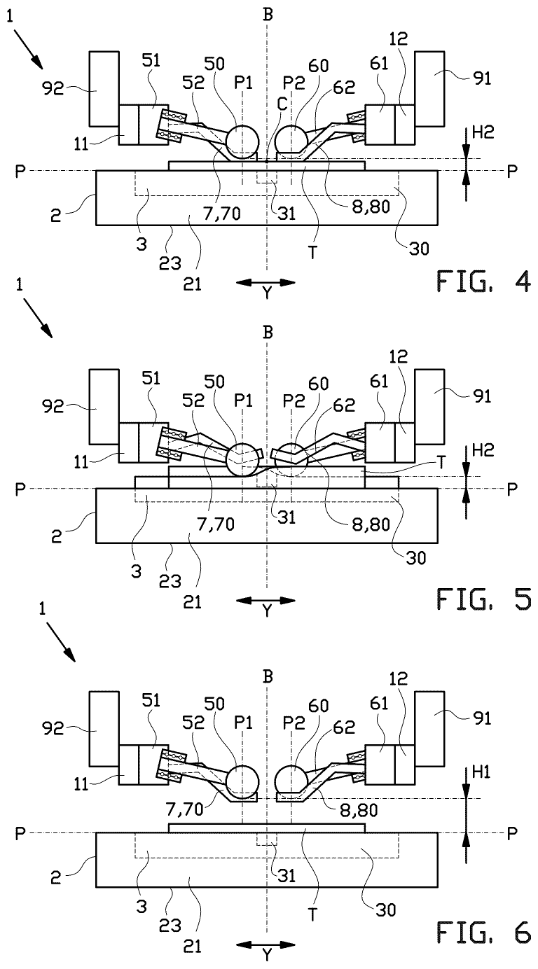

Once the cut has been completed, the hold-down units 5, 6 and the clamp units 7, 8 may be lifted to the first distance H1, as shown in FIGS. 3 and 6. Meanwhile, the lifting beam 3 has been lowered. The tire component T can now be conveyed or advanced without interference by the hold-down units 5, 6 and the clamp units 7, 8. As mentioned earlier, the hold-down units 5, 6 and the clamp units 7, 8 do not necessarily move simultaneously and may be controlled individually, independently or in groups depending on the process requirements.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the invention provides a cutting device 1, 401, 501 and a method for cutting a tire component T, wherein the cutting device 1, 401, 501 comprises a conveyor 2 that defines a conveyor plane P, wherein the cutting device 1, 401, 501 comprises a lifting beam 3 for lifting the tire component T up from the conveyor plane P in a lift direction L, wherein the cutting device 1, 401, 501 is provided with a knife 40 for cutting the tire component T along a cutting line K intersecting with the lifting beam 3 at a cutting center C at an oblique cutting angle V, wherein the cutting device 1, 401, 501 is provided with a first hold-down unit 5, 105, 205, 305, 405 for holding down the tire component T towards the conveyor 2 in a hold-down direction H opposite to the lift direction, wherein the first hold-down unit 5, 105, 205, 305, 405 comprises a contact member 50, 150, 250, 350 for holding down the tire component T in the hold-down direction H towards the conveyor 2 at a first hold-down position P1 within a hold-down radius R of less than one-hundred millimeters from the cutting center C.

### LIST OF REFERENCE NUMERALS

1 cutting device
11 first holder
12 second holder
2 conveyor
21 first conveyor section
22 second conveyor section
23 first conveyor belt
24 second conveyor belt
3 lifting beam
30 beam body
31 cutting recess
4 cutter
40 knife
41 knife holder
42 cutting beam
5 first hold-down unit
50 contact member
51 base
52 support member
53 rotational bearing
6 second hold-down unit
60 contact member
61 base
62 support member
63 rotational bearing
7 first clamp unit
70 finger
8 second clamp unit
80 finger
91 first drive
92 second drive
105 alternative first hold-down unit
150 contact member
151 base
152 support member
153 rotational bearing
205 further alternative first hold-down unit
250 contact member
251 base
252 support member
305 further alternative first hold-down unit
350 contact member
351 base
352 support member
355 rounded edge
401 alternative cutting device
405 first hold-down unit
406 second hold-down unit
407 first clamp unit
408 second clamp unit
491 first drive
492 second drive
493 third drive
494 fourth drive
501 further alternative cutting device
504 cutter
542 cutting beam
543 first holder
544 second holder
A1 first hold-down area
A2 second hold-down area
B cutter axis
C cutting center
D outer diameter
E rolling angle
F conveyance direction
G1 first rolling axis
G2 second rolling axis
H hold-down direction
H1 first distance
H2 second distance
J hold-down distance
K cutting line
L lift direction
M spacing distance
N centerline
P conveyor plane
P1 first hold-down position
P2 second hold-down position
R hold-down radius
S1 first side
S2 second side
T tire component
V cutting angle
W component width
X longitudinal direction
Y lateral direction
Z center axis

1-34. (canceled)

35. A cutting device for cutting a tire component, the cutting device comprising a conveyor that defines a conveyor plane for conveying the tire component in a conveyance direction parallel to said conveyor plane,
wherein the cutting device further comprises a lifting beam for lifting the tire component up from the conveyor plane in a lift direction,
wherein the cutting device is provided with a knife for cutting the tire component along a cutting line intersecting with the lifting beam at a cutting center at an oblique cutting angle,
wherein the cutting device is provided with a first hold-down unit for holding down the tire component towards the conveyor in a hold-down direction opposite to the lift direction,
wherein the first hold-down unit comprises a contact member for holding down the tire component in the hold-down direction towards the conveyor at a first hold-down position adjacent to the lifting beam within a hold-down radius of less than one-hundred-and-fifty millimeters from the cutting center.

36. The cutting device according to claim 35, wherein the hold-down radius is less than eighty millimeters from the cutting center.

37. The cutting device according to claim 35, wherein the first hold-down position is spaced apart from the cutting line in a direction perpendicular to said cutting line over a hold-down distance of less than eighty millimeters.

38. The cutting device according to claim 35, wherein the cutting device comprises a knife holder for moving the knife along the cutting line,
wherein the contact member extends at least partially between the knife holder and conveyor for at least one value of the oblique cutting angle and in at least one position of the knife along the cutting line.

39. The cutting device according to claim 35, wherein the first hold-down unit comprises a base for holding the contact member in the first hold-down position and a support member for interconnecting the contact member with the base.

40. The cutting device according to claim 39, wherein the support member spaces the contact member apart from the base over a spacing distance of at least fifty millimeters.

41. The cutting device according to claim 35, wherein the contact member is rotatable about a first rolling axis.

42. The cutting device according to claim 41, wherein the first rolling axis extends at an oblique rolling angle to the conveyor plane.

43. The cutting device according to claim 42, wherein the oblique rolling angle is within a range of one to forty-five degrees.

44. The cutting device according to claim 41, wherein the first hold-down unit comprises a rotational bearing coaxial to the first rolling axis.

45. The cutting device according to claim 44, wherein the first hold-down unit comprises a base for holding the contact member in the first hold-down position and a support member for interconnecting the contact member with the base,
wherein the rotational bearing is located between the base and the support member.

46. The cutting device according to claim 45, wherein the support member extends coaxially to the first rolling axis.

47. The cutting device according to claim 45, wherein the support member is rotationally fixed with respect to the contact member.

48. The cutting device according to claim 45, wherein the contact member and the support member are integrally formed.

49. The cutting device according to claim 44, wherein the first hold-down unit comprises a base for holding the contact member in the first hold-down position and a support member for interconnecting the contact member with the base,
wherein the rotational bearing is located between the support member and the contact member.

50. The cutting device according to claim 35, wherein the contact member is at least partially spherical.

51. The cutting device according to claim 35, wherein the contact member comprises a beveled, chamfered or rounded edge.

52. The cutting device according to claim 35, wherein the contact member has an outer dimension in the hold-down direction of less than thirty millimeters.

53. The cutting device according to claim 35, wherein the first hold-down unit is arranged for holding down the tire component towards the conveyor at a first side of the cutting line.

54. The cutting device according to claim 53, wherein the contact member of the first hold-down unit is fully located in a first hold-down area included in an obtuse angle between the cutting line and the lifting beam at the first side of said cutting line.

55. The cutting device according to claim 53, wherein the cutting device comprises a second hold-down unit with a contact member for holding down the tire component in the hold-down direction towards the conveyor at a second hold-down position adjacent to the lifting beam at a second side of the cutting line opposite to the first side.

56. The cutting device according to claim 55, wherein the contact member of the second hold-down unit is fully located in a second hold-down area included in an obtuse angle between the cutting line and the lifting beam at the second side of said cutting line.

57. The cutting device according to claim 55, wherein the second hold-down position is within the hold-down radius from the cutting center.

58. The cutting device according to claim 35, wherein the cutting device is provided with a first clamp unit for clamping the tire component on the lifting beam at a first side of the cutting line.

59. The cutting device according to claim 58, wherein the first clamp unit is arranged to move together with the first hold-down unit.

60. The cutting device according to claim 58, wherein the cutting device is provided with a first holder for simultaneously supporting the first hold-down unit and the first clamp unit.

61. The cutting device according to claim 58, wherein the first clamp unit comprises a finger.

62. The cutting device according to claim 61, wherein the finger is resilient.

63. The cutting device according to claim 58, wherein the cutting device is provided with a second clamp unit for clamping the tire component on the lifting beam at a second side of the cutting line, opposite to the first side.

64. The cutting device according to claim 63, wherein the cutting device comprises a second hold-down unit for holding down the tire component in the hold-down direction towards the conveyor at the second side of the cutting line,
wherein the second clamp unit is arranged to move together with the second hold-down unit.

65. A method for cutting a tire component, the method comprising the steps of:
providing a conveyor that defines a conveyor plane;
providing the tire component on the conveyor in said conveyor plane;
lifting the tire component up from the conveyor plane in a lift direction using a lifting beam;
cutting the tire component along a cutting line intersecting with the lifting beam at a cutting center at an oblique cutting angle; and
holding down the tire component towards the conveyor at a first hold-down position adjacent to the lifting beam within a hold-down radius of less than one-hundred-and-fifty millimeters from the cutting center.

66. The method according to claim 65, wherein the tire component has a component width in a lateral direction perpendicular to a conveyance direction of less than one-hundred millimeters.

67. The method according to claim 65, wherein the tire component is a breaker ply or a chafer.

68. The method according to claim 65, wherein the cutting angle is adjustable within a range of fifteen to seventy degrees.
